(19) United States
(12) Patent Application Publication
(10) Pub. No.: US 2026/0098814 A1
(43) Pub. Date: Apr. 9, 2026

(54) REAGENT SYSTEM FOR ACRIDINIUM ESTER CHEMILUMINESCENCE AND METHOD OF DETECTING TARGET ANTIGEN USING THE SAME

(71) Applicant: Ji Hoon LEE, Gaithersburg, MD (US)

(72) Inventor: Ji Hoon LEE, Gaithersburg, MD (US)

(21) Appl. No.: 18/907,397

(22) Filed: Oct. 4, 2024

(51) Int. Cl. G01N 21/76

(52) U.S. Cl. CPC G01N 21/763

(57) ABSTRACT

Provided is a reagent system for acridinium ester chemiluminescence, and a method of detecting a target antigen using the same. The reagent system for eliciting an acridinium ester chemiluminescence includes: a first reagent including a graphene-based material, hydrogen peroxide and an acid; and a second reagent including a base and a surfactant, where the concentration of the graphene-based material is 0.5 μg/ml or more and 6 μg/ml or less, where the hydrogen peroxide has a concentration of 5 to 20 mM, and where the acid has a concentration of 1 to 24 mM. The reagent system offers a significant improvement over conventional methods, with lower reagent concentrations and stability over extended storage, suitable for sensitive and precise immunocomplex quantification.

### TECHNICAL FIELD

The present disclosure relates to a reagent system for acridinium ester chemiluminescence, and a method of detecting a target antigen using the same.

### BACKGROUND

Details in the background section do not constitute the related art but are given only as background information concerning the subject matter of the present disclosure.

Acridinium ester chemiluminescence has been known as a popular direct detection method for immunoassays that does not require enzyme labels like horseradish peroxidase (HRP) or alkaline phosphatase (AP). In a typical sandwich immunoassay using this technique, the detection antibodies are conjugated with acridinium ester. After the immunoreaction between sample antigens and the detection antibodies, a certain volume (e.g., 100-300 μL) of high concentration hydrogen peroxide (e.g., 100-200 mM) in a strong acid (e.g., 0.1 N of HNO₃ or H₂SO₄) is added to the assay well. This rapidly disperses and stabilizes the acridinium ester-labeled immunocomplex in the acidic solution. Once an equilibrium condition is reached, a certain volume (e.g., 100-300 μL) of concentrated sodium hydroxide (e.g., 250-500 mM) is injected. The strong basic solution (>pH 13) triggers the acridinium ester to produce a flash of blue chemiluminescence as shown in FIG. 1. While acridinium ester chemiluminescence provides more sensitive detection for sandwich immunoassays compared to enzyme-based chemiluminescence, there are some downsides to this approach.

For example, the concentrated reagents used in the process—hydrogen peroxide, strong acids, and strong bases—can be hazardous. Handling and disposing of these materials require special precautions to avoid environmental issues. Additionally, depending on the reagents and buffer agents, the acridinium esters may exhibit background luminescence in the absence of the target analyte. This non-specific signal can potentially interfere with the accuracy of the assay and may necessitate additional steps to reduce background noise.

Therefore, there is a need to develop a new reagent for performing the acridinium ester chemiluminescence which is environmentally friendly and cost-effective, and that has low signal-to-background ratio, higher sensitivity, and faster performance.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure provides a solution to the limitations of conventional reagents, offering a safer, more environmentally friendly, and sensitive approach to the detection of acridinium ester-labeled immunocomplexes, suitable for a wide range of applications in biochemical diagnostics.

The present disclosure has been made to solve the above-mentioned problems and other technical problems that have yet to be resolved.

An object of the present disclosure is to provide a reagent system having two distinct reagents that facilitate a background-free analytical system for evaluating acridinium ester-labeled immunocomplexes from antigen-antibody interactions in immunoassays.

Another object of the present disclosure is to provide a method for detecting target antigens using reagents that offer environmental benefits, cost efficiency, a low signal-to-background ratio, enhanced sensitivity, and rapid performance.

To fulfill the stated objective, an embodiment of the present disclosure provides a reagent system for eliciting an acridinium ester chemiluminescence, including: a first reagent including a graphene-based material, hydrogen peroxide and an acid; and a second reagent including a base and a surfactant, wherein the graphene-based material has a concentration of 0.5 g/ml or more to 6 μg/ml or less, wherein the hydrogen peroxide has a concentration of 5 to 20 mM, and wherein the acid has a concentration of 1 to 24 mM.

A background signal of the acridinium ester chemiluminescence measured by a luminometer may be either not detected or detected at less than 0.005% of the maximum chemiluminescence intensity measured by the luminometer

The graphene-based material may be selected from the group consisting of graphene, graphene oxide (GO), and reduced graphene oxide (rGO).

The acid may be selected from the group consisting of nitric acid (HNO₃), hydrochloric acid (HCl), ascorbic acid, citric acid, acetic acid, formic acid, oxalic acid, and a combination thereof.

The base may be selected from the group consisting of sodium hydroxide (NaOH), potassium hydroxide (KOH), sodium carbonate, potassium carbonate, ammonium hydroxide, tetra-n-ethylammonium hydroxide (TEA), tetra-n-propylammonium hydroxide (TPA), tetra-n-butylammonium hydroxide (TBA), and a combination thereof.

A concentration of the base in the second reagent may be less than 200 mM.

The base may be one or more of sodium hydroxide (NaOH) and potassium hydroxide (KOH), and a concentration of the base is 50 mM or more and less than 200 mM.

The base may be one or more of tetra-n-ethylammonium hydroxide (TEA), tetra-n-propylammonium hydroxide (TPA) and tetra-n-butylammonium hydroxide (TBA), and a concentration of the base may be 10 mM to 50 mM.

The surfactant may be selected from the group consisting of a cationic surfactant, a neutral surfactant, an anionic surfactant, a non-ionic surfactant, and a combination thereof.

The cationic surfactant may be CTAC (cetyltrimethylammonium chloride) or CTAB (cetyltrimethylammonium bromide).

The surfactant may be CTAC (cetyltrimethylammonium chloride) or CTAB (cetyltrimethylammonium bromide), and a concentration of the surfactant may be 5 to 50 mM.

The neutral surfactant may be one or more selected from the group consisting of polyethylene glycol tert-octylphenyl ether derivatives (e.g., Triton X-45, Triton X-100, Triton X-102, Triton X-114, Triton X-165, Triton X-305, Triton X-405, Triton X-705) and/or polyoxyethylenesorbitan monopalmitate derivatives (e.g., Tween 20, Tween 40, Tween 60, Tween 80).

The anionic surfactant may be ammonium dodecyl sulfate (ADS) or sodium dodecyl sulfate (SDS).

The surfactant may be ammonium dodecyl sulfate (ADS) or sodium dodecyl sulfate (SDS), and a concentration of the surfactant may be 5 to 60 mM.

The non-ionic surfactant may comprise one or more of sorbitan monolaurate (SPAN 20) and cyclodextrins.

A concentration of the surfactant may be 0.1 mM to 100 mM.

The pH of the second reagent may be 12.6 to 13.1.

The second reagent may further include an alkali metal salt having a halogen ion of F⁻, Cl⁻ or Br⁻.

The alkali metal salt may be selected from the group consisting of potassium chloride (KCl), sodium chloride (NaCl), cesium chloride (CsCl), sodium bromide (NaBr), potassium bromide (KBr), and sodium fluoride (NaF).

The first reagent may further comprise a chloride ion.

Another embodiment of the present disclosure provides a method of detecting a target antigen in a sample, including: performing an immunoreaction between a target antigen in a sample and a detection antibody conjugated with acridinium ester for sandwich immunoassays or an artificial antigen, which is compatible with the target antigen, conjugated with acridinium ester for competitive immunoassays to form an acridinium ester-labeled immunocomplex; dispersing the acridinium ester-labeled immunocomplex in a first reagent comprising an acid, hydrogen peroxide and a graphene-based material; adding a second reagent including a base and a surfactant into the dispersed acridinium ester-labeled immunocomplex to emit a chemiluminescence signal; and measuring an intensity of the chemiluminescence signal, wherein a concentration of the graphene-based material is 0.5 μg/ml or more to 6 μg/ml or less, wherein a concentration of the hydrogen peroxide is 5 to 20 mM, and wherein a concentration of the acid is 1 to 24 mM.

In the dispersing step, the acridinium ester-labeled immunocomplex and the first reagent may be mixed and incubated for less than 5 minutes to reach an optimal condition to emit chemiluminescence with the addition of the second reagent.

In the dispersing step, the acridinium ester-labeled immunocomplex and the first reagent may be mixed and incubated for less than 1.5 minutes to reach an optimal condition to emit chemiluminescence with the addition of the second reagent.

The sample may be selected from the group consisting of serum, plasma, whole blood, stool, cerebrospinal fluid, synovial fluid, tissue, nasal swabs, and urine.

The sample may be selected from the group consisting of a drinking water, a tap water, a vegetable, a fruit, a meat, and a contaminated material.

The target antigen may be an antigen derived from bacteria, cells, foodborne pathogens, peptides, proteins, haptens, or viruses.

The target antigen may include a small molecule antigen, a non-protein antigen, a cyclic antigen, or a single epitope antigen.

The measuring the intensity of the chemiluminescence signal is performed less than 60 seconds after adding the second reagent.

The second reagent may further comprise an alkali metal salt having a halogen ion of F⁻, Cl⁻ or Br⁻.

The alkali metal salt may be selected from the group consisting of potassium chloride (KCl), sodium chloride (NaCl), cesium chloride (CsCl), sodium bromide (NaBr), potassium bromide (KBr), and sodium fluoride (NaF).

The first reagent may further comprise a chloride ion.

The effects of the exemplary embodiments of the present disclosure are not limited to those mentioned above, and other effects not mentioned may be clearly derived and understood by one having ordinary skill in the art to which the exemplary embodiments of the present disclosure belong from the following description. In other words, unintended effects of practicing the exemplary embodiments of the present disclosure may also be derived from the exemplary embodiments of the present disclosure by one having ordinary skill in the art.

### BRIEF DESCRIPTION OF THE DRAWINGS

The accompanying drawings illustrate an embodiment of the present disclosure and together with the foregoing disclosure, serve to provide further understanding of the technical features of the present disclosure, and thus, the present disclosure is not construed as being limited to the drawing.

FIG. 1 is a schematic view showing the steps for analyzing acridinium ester-labeled immunocomplexes generated via an immunoassay, employing the reagent system according to the present disclosure, including first and second reagents designed to induce chemiluminescence in the presence of the labeled immunocomplexes while eliminating background interference. The first reagent contains graphene oxide (GO), hydrogen peroxide (H₂O₂), and an acid, while the second reagent comprises a base and a surfactant, optionally combined with chloride ions.

FIG. 2 is a graph showing the effect of mixing 0.9 M KCl with 100 mM KOH alone or in combination with 30 mM CTAC on chemiluminescence. The first reagent comprised 1 μg/ml graphene oxide (GO), 15 mM hydrogen peroxide (H₂O₂), and 12 mM citric acid. Four different formulations of the second reagent were tested: (1) solely KOH, (2) KOH with KCl, (3) KOH with CTAC, and (4) KOH combined with both KCl and CTAC. 0.5 ng/ml acridinium ester-labeled immunocomplexes in PBS was used as a control.

FIG. 3 is a graph showing the influence of various halogen ions (F⁻, Cl⁻, Br⁻, and I⁻) from the alkali metal salts on acridinium ester chemiluminescence reactions. Each halogen ion at a concentration of 0.9 M was combined with 100 mM KOH. The first reagent included 1 μg/ml of graphene oxide (GO), 15 mM hydrogen peroxide (H₂O₂), and 12 mM citric acid. A control sample containing 0.5 ng/ml of acridinium ester-labeled immunocomplexes in PBS buffer was utilized for comparison.

FIG. 4A is a graph showing the enhancement in chemiluminescence intensity resulting from the addition of 0.9 M KCl to the second reagent, which also contains 100 mM KOH and 30 mM CTAC. FIG. 4B is a graph showing the impact of adding 0.9 M KCl to the second reagent composed of 100 mM KOH and 0.25% Triton X-100 on chemiluminescence. FIG. 4C is a graph showing the effect of incorporating 0.9 M KCl into the second reagent containing 100 mM KOH and 30 mM SDS on the chemiluminescence reaction. The first reagent included 1 μg/ml of graphene oxide (GO), 15 mM hydrogen peroxide (H₂O₂), and 12 mM citric acid. A control sample containing 0.5 ng/ml of acridinium ester-labeled immunocomplexes in PBS buffer was utilized for comparison.

FIG. 5 is a graph showing the effect of chloride ions in the first reagent in acridinium ester chemiluminescence reaction. The first reagent contains 1 μg/ml GO, 15 mM H₂O₂, and 12 mM citric acid with or without chloride ions, respectively. The second reagent contains 100 mM NaOH and 2% Triton X-100. A control sample containing 1 ng/ml of acridinium ester-labeled immunocomplexes in 10 mM sodium phosphate buffer (pH 7.5) was utilized for comparison.

FIG. 6 is an illustration of graphene oxide (GO).

### DETAILED DESCRIPTION

Hereinafter, the present disclosure will be described in more detail for a better understanding of the invention.

While the present disclosure is open to various modifications and alternative embodiments, specific embodiments thereof will be described and illustrated by way of example in the accompanying drawings. However, this is not purported to limit the present disclosure to a specific disclosed form, but it shall be understood to include all modifications, equivalents and substitutes within the idea and the technological scope of the present disclosure.

In this application, it should be understood that terms such as “include” or “have” are intended to indicate that there is a feature, number, step, operation, component, part, or a combination thereof described on the specification, and they do not exclude in advance the possibility of the presence or addition of one or more other features or numbers, steps, operations, components, parts or combinations thereof.

Hereinafter, the present disclosure will be described in detail.

According to one embodiment of the present disclosure, a reagent system for acridinium ester chemiluminescence including a first reagent and a second reagent is provided. The first reagent can be used for dispersing and stabilizing the acridinium ester-labeled immunocomplex, and can comprise a graphene-based material, hydrogen peroxide and an acid. The second reagent can be used for triggering the chemiluminescence, and the second reagent includes a base and a surfactant.

In the present disclosure, “a background-free” means that a background signal of the acridinium ester chemiluminescence measured by a luminometer in the absence of the acridinium ester-labeled immunocomplex is either not detected or detected at less than 0.005% of the maximum chemiluminescence intensity measured by the luminometer.

A graphene-based material, for example, a graphene oxide (GO), can play a multifaceted role in the advanced first reagent for the acridinium ester chemiluminescence reaction. It can act as a background inhibitor, significantly reducing background noise by about 5.2 times lower than that observed with conventional first reagents, which can be critical for enhancing the specificity and sensitivity of the detection system. The graphene-based material can also serve as a potent enhancer of the relative chemiluminescence intensity (RCL), particularly in the presence of acridinium ester-labeled immunocomplexes. This is evidenced by an improved RCL to background ratio (RCL/B=23.62) when the graphene-based material (e.g., GO) is present, compared to a lower ratio (RCL/B=4.24) without it. Additionally, the inclusion of graphene-based material can allow for a 67-fold reduction in the concentration of hydrogen peroxide (H₂O₂) in the first reagent, while still observing higher RCL, indicating that the graphene-based material can amplify the oxidative effects of H₂O₂ in the reaction. In summary, the graphene-based material can enhance the assay's performance, making the system more environmentally friendly and cost-effective due to the reduced reliance on high concentrations of reactive chemicals such as H₂O₂, and acid in the first reagent, and base in the second reagent. The optimal concentration of the graphene-based material, crucial for its effectiveness, can be meticulously adjusted within the compositions of the first and second reagents.

The graphene-based material can comprise one or more of graphene, graphene oxide (GO), and reduced graphene oxide (rGO). Preferably, the graphene-based material can be graphene oxide (GO). The graphene-based material can be included in the first reagent in an amount of 0.1 μg/ml or more, 0.5 g/ml or more, 0.7 μg/ml or more, 1.0 μg/ml or more, 1.5 μg/ml or more, or 3.0 g/ml or more, and 100 μg/ml or less, or 50 μg/ml or less. Preferably, the graphene-based material can be included in the first reagent in a range of 0.5 μg/ml or more to 6 μg/ml or less.

Hydrogen peroxide (H₂O₂) can serve as a critical oxidizing agent in the acridinium ester chemiluminescence reaction, facilitating the emission of light upon interaction with the acridinium-labeled immunocomplexes. The optimal concentration range of H₂O₂ is crucial for balancing the intensity of the chemiluminescence signal and minimizing background noise. Lower concentrations of H₂O₂, as enabled by the presence of the graphene-based material in the reagent formulation provided herein, can significantly enhance the sensitivity and specificity of the assay. The ideal concentration range of H₂O₂ for achieving efficient chemiluminescence while maintaining a background-free analysis can be typically less than 200 mM, with concentrations as low as 5 to 50 mM, or preferably, 5 to 20 mM, being effective in the presence of the graphene-based material. This reduced H₂O₂ concentration can contribute to a safer, more environmentally friendly system and can reduce the potential for oxidative damage to the biomolecules involved in the assay.

The acid component in the first reagent can play a pivotal role in optimizing the pH environment for the acridinium ester chemiluminescence reaction, thereby enhancing the stability and dispersion of acridinium ester-labeled immunocomplexes. This pH adjustment can be crucial for maximizing the efficiency of the chemiluminescence signal while ensuring the stability of all components involved in the reaction. Possible types of acids that can be incorporated include both strong and weak acids, such as nitric acid (HNO₃), hydrochloric acid (HCl), ascorbic acid, citric acid, acetic acid, formic acid, oxalic acid, or a combination thereof. These acids can be selected based on their ability to achieve the desired pH without adversely affecting the reaction components or the stability of the acridinium ester-labeled immunocomplexes. The optimal concentration range for the acid in the first reagent can be determined to ensure effective pH control without contributing to background noise or interfering with the chemiluminescence reaction. Typically, the concentration of the acid can be kept below 50 mM to maintain a balance between reaction efficiency and component stability. This concentration range, 1 to 50 mM, or preferably, 1 to 24 mM, can allow for the precise adjustment of the reaction environment, ensuring that the assay operates under optimal conditions for sensitive and specific detection of target analytes.

The strong base in the second reagent can be crucial for adjusting the pH of the final solution, containing the sample and both reagents, to an optimal range (pH 12-13.2) for acridinium ester chemiluminescence. This pH adjustment can be essential for ensuring the chemiluminescence reaction proceeds efficiently, generating a strong signal without the interference of background noise, thereby facilitating a background-free condition. Types of bases used in acridinium ester chemiluminescence can include sodium hydroxide (NaOH), potassium hydroxide (KOH), sodium carbonate (Na₂CO₃), potassium carbonate (K₂CO₃), ammonium hydroxide (NH₄OH), and tetraalkylammonium hydroxides such as tetra-n-ethyl ammonium hydroxide (TEA), tetra-n-propyl ammonium hydroxide (TPA), and tetra-n-butyl ammonium hydroxide (TBA), and a combination thereof. These bases can be selected for their ability to achieve and can maintain the desired pH level effectively. The optimal concentration of the base in the second reagent can be determined based on the acid concentration in the first reagent. This careful balancing ensures that the acid's effect can be neutralized, achieving the desired pH range that is critical for the chemiluminescence reaction. Typically, the concentration of the base can be adjusted to be less than 200 mM, ensuring that the final solution's pH is within the optimal range for chemiluminescence while maintaining the stability of the immunocomplexes and other reaction components. This strategic approach to selecting and balancing the base's concentration relative to the acid's ensures that the chemiluminescence detection system can operate under optimal conditions, maximizing sensitivity and specificity in the detection of target analytes under a background-free analytical environment.

Surfactants are essential in acridinium ester chemiluminescence, enhancing reactant solubility and signal efficiency. They can include cationic types like cetyltrimethylammonium bromide (CTAB) and cetyltrimethylammonium chloride (CTAC), which improve charge interactions; anionic surfactants such as sodium dodecyl sulfate (SDS) and ammonium dodecyl sulfate (ADS), stabilizing charged complexes; and neutral surfactants like the Triton X (e.g., Triton X-45, Triton X-100, Triton X-114, Triton X-405, Triton X-705) and Tween (e.g., Tween 20, Tween 40, Tween 60, Tween 80) series, optimizing solubility without altering ionic strength. Additionally, non-ionic surfactants, including sorbitan monolaurate (SPAN 20) and cyclodextrins (e.g., γ-cyclodextrin, α-cyclodextrin, β-cyclodextrin, methyl-β-cyclodextrin, carboxymethyl-β-cyclodextrin), can offer solubility improvements without contributing to ionic strength. The optimal surfactant choice and concentration, typically ranging from 0.1 mM to 100 mM, depend on their interaction with the chemiluminescence system, aiming to maximize reaction conditions while minimizing background noise, thus enhancing the detection system's sensitivity and specificity.

Halogen ions derived from the alkali metal salt can modulate acridinium ester chemiluminescence, with specific ions acting as enhancers or quenchers of the chemiluminescence reaction. Chloride (Cl⁻), fluoride (F⁻), and bromide (Br⁻) ions are known to enhance the chemiluminescence signal, with chloride ions being particularly effective in boosting the intensity of the emitted light. In contrast, iodide (I⁻) ions act as strong quenchers, diminishing the chemiluminescence signal. Possible alkali metal salts that can be used to introduce these halogen ions into the chemiluminescence system can include potassium chloride (KCl), sodium chloride (NaCl), cesium chloride (CsCl), sodium bromide (NaBr), potassium bromide (KBr), and sodium fluoride (NaF). The choice and concentration of these salts can significantly influence the chemiluminescence outcome, making it crucial to select the appropriate halogen ion and salt concentration to achieve optimal signal enhancement while maintaining a background-free analysis environment. The optimal concentration range of halogen (e.g., chloride) ions to enhance chemiluminescence in acridinium ester chemiluminescence reactions typically falls within 0.3 to 2 M. This range can be effective for boosting the chemiluminescence signal while maintaining the assay's specificity and sensitivity. It's important to carefully adjust the halogen (e.g., chloride) ion concentration within this range to optimize the chemiluminescence output without introducing background noise or negatively impacting the reaction kinetics.

The first reagent, utilized for dispersing and stabilizing the acridinium ester-labeled immunocomplex, can contain hydrogen peroxide and an acid with graphene oxide. The second reagent, responsible for initiating chemiluminescence, can comprise a base and a surfactant, and can also include halogen ions derived from salts of alkali metals.

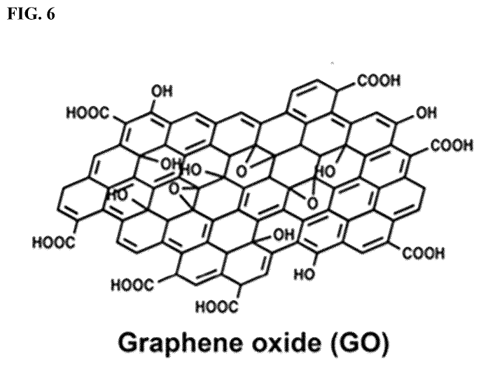

Graphene-based material, for example, graphene oxide which is adorned with hydrophilic functional groups such as aldehyde, carboxylic, and hydroxyl on its inherently hydrophobic surface (FIG. 6), can markedly enhance the chemiluminescence intensity of acridinium ester in the presence of a relatively low hydrogen peroxide (H₂O₂) concentration range (e.g., 5-20 mM) and low concentrations (e.g., 1-24 mM) of either strong or weak acids, including hydrogen chloride (HCl), hydrogen nitrate (HNO₃), citric acid, acetic acid, ascorbic acid, and oxalic acid. This enhancement can be attributed to the graphene-based material's ability to rapidly disperse acridinium ester-labeled immunocomplexes and preserve their stability prior to the addition of the second reagent, eliminating the need for excessive acid typically required in the absence of the graphene-based material. Furthermore, the graphene-based material can serve as an oxidizing agent, producing intense chemiluminescence with relatively low hydrogen peroxide concentrations.

The addition of the graphene-based material to the first reagent can result in enhanced chemiluminescence intensity. Nonetheless, the signal-to-background ratio (S/B) can be influenced by the concentration of the graphene-based material. Background levels can be assessed using a luminometer (Lumat 9507, Berthold Inc.) in the absence of the acridinium ester-labeled immunocomplex. As the concentration of the graphene-based material increases, there is a reduction in S/B, attributed to a disproportionately larger increase in background relative to the signal enhancement. In essence, the background can diminish when the graphene-based material (e.g., GO) concentrations can be as low as 0.5 to 6 μg/ml, despite a minor reduction in signal intensity compared to higher GO concentrations (e.g., >12 μg/ml). This outcome can suggest the feasibility of a background-free detection system, enabling the accurate and precise quantification of trace amounts of acridinium-labeled immunocomplexes formed through the reaction between an antigen and antibodies. Therefore, the relative chemiluminescence intensity in a calibration curve can be solely dependent on the presence of acridinium-labeled immunocomplexes in a sample, unaffected by background interference. Thus, analysis utilizing a first reagent containing the graphene-based material can offer significantly higher sensitivity compared to traditional approaches that use first reagents with excess H₂O₂ (e.g., >200 mM) and concentrated strong acids (e.g., HNO₃), which tend to produce high background levels.

In the first reagent containing the graphene-based material, ranging from 0.5 to 6 μg/ml, H₂O₂ can enhance the relative chemiluminescence intensity without causing background interference. As the concentration of H₂O₂ increases from 5 to 20 mM, the relative chemiluminescence (CL) intensity becomes more pronounced. The optimal concentration of H₂O₂ can be influenced by the properties of the base (e.g., NaOH, KOH, tetra-n-propylammonium hydroxide) and the surfactant (e.g., cationic, neutral, anionic) used in the second reagent. It is observed that increasing the H₂O₂ concentration beyond 20 mM to up to 200 mM may not significantly affect the relative chemiluminescence intensity, with variations remaining within a statistically acceptable error margin (+5%). The data show that the concentration of H₂O₂ required for conducting a background-free analysis with the first reagent containing the graphene-based material can be at least ten times lower than that used in conventional analysis systems that do not include the graphene-based material.

For the first reagent, which includes optimal concentration ranges of the graphene-based material and H₂O₂ for analyzing acridinium-labeled immunocomplexes without background interference, the suitable concentration range of an acid (e.g., acetic acid, ascorbic acid, citric acid, HCl, HNO₃, oxalic acid) can be established. The acids can be added in concentrations ranging from 1 to 24 mM, suitable for the background-free analysis system. This range can be deemed independent of the acid's strength because the strong base concentrations (e.g., 40-150 mM) in the second reagent may be sufficient to neutralize the acid from the first reagent, thereby maintaining a pH conducive to producing robust chemiluminescence. Negligible differences in the relative chemiluminescence intensity between strong and weak acids can be observed, attributable to slight pH variations in the mixture of the first and second reagents. Thus, the background-free analysis system can operate effectively with the first reagent containing a relatively low concentration of either strong or weak acid. In contrast, conventional analysis systems that generate higher background levels typically require the first reagent to contain concentrated strong acid.

In the background-free analysis system, the second reagent can include one of several strong bases to initiate the chemiluminescence reaction of acridinium ester. Sodium hydroxide (NaOH) and potassium hydroxide (KOH) can serve similar roles with appropriate concentration ranges of 50-200 mM. In contrast, tetra-n-ammonium hydroxide derivatives, such as tetra-n-ethylammonium hydroxide (TEA), tetra-n-propylammonium hydroxide (TPA), and tetra-n-butylammonium hydroxide (TBA), have different suitable concentration ranges of 10-50 mM compared to NaOH and KOH. The effectiveness of each base in triggering the acridinium ester chemiluminescence reaction varies depending on the type of surfactants (e.g., cationic, neutral, anionic) present in the second reagent.

CTAC (cetyltrimethylammonium chloride) and CTAB (cetyltrimethylammonium bromide), as cationic surfactants, can significantly enhance acridinium ester chemiluminescence in the presence of strong bases like NaOH or KOH, with CTAC being more effective than CTAB. This superior performance of CTAC can be attributed to the specific influence of chloride ions (Cl⁻) over bromide ions (Br⁻) and its greater solubility in basic solutions. Chloride ions in CTAC can foster more favorable interactions within the chemiluminescence reaction environment, potentially due to factors like their smaller ionic radius, differing hydration energies, or specific interactions with the reaction components. Moreover, the higher solubility of CTAC in basic conditions can promote a more uniform distribution of surfactant molecules, enhancing surface tension reduction and interaction among reaction components. These aspects, such as ion specificity and solubility characteristics, can contribute to CTAC's enhanced performance in acridinium ester chemiluminescence, with an optimal concentration range extending from 5 to 50 mM, depending on the specific compositions of the first and second reagents.

Background can be detected when the concentration of NaOH (or KOH) in the second reagent, combined with CTAC, is below 50 mM, with the intensity of this background increasing as the base concentration decreased, leading to a lower pH in the second reagent. No background can be observed with concentrations of NaOH (or KOH) of 50 mM or higher, up to 200 mM, as the pH of the second reagent increased. The relative chemiluminescence intensity produced by a second reagent with 50 mM NaOH (or KOH) can be comparable to that from a reagent with 150 mM NaOH. However, the relative chemiluminescence intensity with 200 mM NaOH can be found to be lower than that with concentrations ranging from 50 to 150 mM NaOH. These results demonstrate that the background-free analysis system for acridinium ester chemiluminescence detection functions optimally within a specific pH range of 12.6 to 13.1 for the second reagent. This is despite the fact that operating the system at a pH higher than 13.1 results in no background interference but with a relatively lower signal intensity.

However, neither CTAC nor CTAB can effectively enhance acridinium ester chemiluminescence in the presence of tetra-n-ammonium hydroxide derivatives like TEA, TPA, and TBA. This lack of enhancement is likely due to the shared quaternary ammonium ion characteristic between CTAC/CTAB and tetra-n-ammonium hydroxide derivatives. The similar ionic environment created by these quaternary ammonium ions might not significantly alter or enhance the chemiluminescence reaction, as the chemical structure and properties of the quaternary ammonium groups in both CTAC/CTAB and tetra-n-ammonium hydroxide derivatives do not provide distinct ionic or surfactant effects necessary for significant chemiluminescence enhancement.

Neutral surfactants such as Triton X derivatives (e.g., Triton X-45, Triton X-100, Triton X-114, Triton X-405, Triton X-705, a common nonionic surfactant used for its wetting and detergency properties) and Tween derivatives (e.g., Tween 20, Tween 40, Tween 60, Tween 80, known for its emulsifying and stabilizing capabilities) can significantly enhance acridinium ester chemiluminescence in strong basic solutions, regardless of the base type (NaOH, KOH, or tetra-n-ammonium hydroxide derivatives like TEA, TPA, TBA). The enhancement effect can be proportional to the concentration of the surfactant, with the optimal volume percentage (v/v) depending on the surfactant's properties and the composition of both the first and second reagents.

Low concentrations of neutral surfactants in a basic solution can enable the immediate operation of a background-free analysis system for tracing analyte quantification. For instance, up to 0.2% Triton X-100 in NaOH or KOH, or up to 0.5% in a tetra-n-ammonium hydroxide derivative, can allow for the quantification of acridinium ester-labeled immunocomplexes without background interference. However, exceeding these Triton X-100 concentrations introduces a background from the surfactant-base hydration, though it remains significantly lower than the enhanced chemiluminescence signal. This background decreases after 24-48 hours as the second reagent stabilizes, allowing for background-free measurements. The chemiluminescence intensity post-stabilization can correlate with the Triton X-100 concentration, improving within a 0.2-3% range. This stabilized second reagent maintains consistent relative chemiluminescence intensity for at least three weeks, within a ±5% error range, indicating that Triton X-100 concentration directly influences the second reagent's shelf-life.

The background-free analysis system can be developed using a combination of anionic surfactants, specifically SDS (sodium dodecyl sulfate) and ADS (ammonium dodecyl sulfate), with strong bases such as NaOH, KOH, and tetra-n-ammonium hydroxide derivatives (e.g., TEA, TPA, TBA). The effectiveness of SDS in enhancing the chemiluminescence reaction can be found to be superior to that of ADS. For this system, the suitable concentration ranges for NaOH (or KOH) and tetra-n-ammonium hydroxide derivatives can be identified as 75-150 mM and 20-50 mM, respectively. The optimal concentration range for SDS within this background-free analysis system can be established at 30-40 mM, although the system could operate without background using SDS concentrations ranging from 5 to 60 mM. Notably, the relative chemiluminescence intensity produced with a second reagent containing 30 mM SDS and 40 mM TPA can surpass that of a stabilized second reagent created from the hydration of 3% Triton X-100 with 150 mM NaOH over two days. Furthermore, a second reagent of 30 mM SDS and 40 mM TPA, when prepared in a polypropylene vial, can be remained stable at room temperature for up to a month. Once the vial was opened, the second reagent could be efficiently used in a luminometer to initiate the acridinium ester chemiluminescence reaction, maintaining its effectiveness for 5 to 7 days.

In the second reagent comprised solely of NaOH (or KOH) without any cationic surfactant, chloride ions can serve as enhancers for the acridinium ester chemiluminescence reaction. Similarly, fluoride and bromide ions also can act as enhancers, albeit at a lower effectiveness compared to chloride ions. This difference in enhancement rates underscores the specific influence of halide ion characteristics on the chemiluminescence reaction. The hierarchy in enhancing abilities—chloride ions being the most effective, followed by fluoride and bromide ions—suggests that the ionic radius and electron affinity of these ions can play crucial roles in their interaction with the acridinium ester. On the contrary, the addition of iodide ions to NaOH (or KOH) resulted in the absence of chemiluminescence, indicating that iodide ions act as a strong quencher of the acridinium ester chemiluminescence reaction. This quenching effect of iodide ions can be attributed to their larger ionic radius and lower energy of hydration, which may facilitate a more efficient energy transfer mechanism that inhibits chemiluminescence. This nuanced interaction between different halide ions and the chemiluminescence reaction highlights the importance of ion selection in optimizing the sensitivity and specificity of acridinium ester-based detection systems. Alkali metal ions (e.g., Li⁺, Na⁺, K⁺, Cs⁺) from salts paired with chloride ions can exhibit no interaction with the chemiluminescence reaction, neither enhancing nor reducing the acridinium ester chemiluminescence. This neutrality in effect can suggest that the presence of these metal ions does not significantly influence the reaction's outcome.

In a background-free analysis system utilizing acridinium ester chemiluminescence detection, the addition of chloride ions to the second reagent, which contains a cationic surfactant such as CTAC or CTAB, can significantly enhance the chemiluminescence reaction. The presence of 1 M chloride ions resulted in a relative chemiluminescence intensity approximately 40% higher than when chloride ions were absent. This enhancement effect can be attributed to the synergistic interaction between the chloride ions and the cationic surfactant molecules, which likely facilitates a more efficient electron transfer or alters the microenvironment around the acridinium ester, thereby increasing the efficiency of the chemiluminescence process. The role of chloride ions in this context can highlight their potential to influence reaction kinetics and efficiency, possibly by affecting the solubility, stability, or reactivity of the acridinium ester and surfactant complex. This finding can emphasize the importance of ion selection in optimizing the performance of chemiluminescence-based detection systems, offering valuable insights for the design of highly sensitive and specific analytical assays. The enhancement can be observed in the range (0.6-1.5 M) of chloride ions added in the second reagent. The optimal concentration of chloride ions for the acridinium ester chemiluminescence reaction can be contingent upon the specific compositions and their respective concentrations within the second reagent. This dependency underscores the importance of carefully balancing the chemical constituents of the reaction mixture to achieve maximum chemiluminescence intensity. The interaction between chloride ions and other components, such as cationic surfactants and the base in the second reagent, can significantly influence the reaction's efficiency. Thus, determining the optimal chloride ion concentration can involve considering the synergistic and antagonistic effects these ions may have with other ingredients in the reaction mixture, aiming to fine-tune the conditions for optimal performance of the chemiluminescence detection system.

The presence of chloride ions in the second reagent, which contains neutral surfactants like Triton X-100, can result in a relative chemiluminescence intensity that may be slightly higher than or roughly equivalent to the intensity observed in their absence. This suggests that while chloride ions may have a minimal enhancing effect on the chemiluminescence reaction in the presence of neutral surfactants, their impact cannot be as pronounced as when cationic surfactants are used. The subtle difference in chemiluminescence intensity can indicate that the interaction between chloride ions and the components of the second reagent, particularly neutral surfactants, may not significantly alter the efficiency of the chemiluminescence process.

The addition of chloride ions to the second reagent containing the anionic surfactant SDS can result in the formation of white precipitation. This occurrence significantly quenched the relative chemiluminescence intensity when such a reagent was introduced into the reaction. The precipitation can suggests an interaction between chloride ions and SDS that leads to reduced solubility, possibly through mechanisms such as the salting-out effect, where the presence of high salt concentrations can decrease the solubility of SDS by competing for water molecules. This reduction in solubility can drastically affect the chemiluminescence reaction, as the precipitated material may impede the necessary interactions between the acridinium ester and other reaction components, thereby diminishing the signal intensity. This highlights the critical role of surfactant solubility and ionic interactions in designing chemiluminescence detection systems, emphasizing the need for careful consideration of reagent compatibility to avoid adverse effects on analytical outcomes.

The presence and concentration of chloride ions in the first reagent can play a critical role in modulating RCL measured in acridinium ester chemiluminescence reaction, with effects varying significantly based on the surfactant used.

Chloride ions, when introduced through the first reagent, can demonstrate a proportional enhancement of RCL up to a certain concentration threshold. This suggests that chloride ions serve as enhancers in the chemiluminescence reaction mechanism facilitated by CTAC. The enhancement peaks at a chloride ion concentration of 0.45 M in the final solution. Beyond this concentration, the salting-out effect attributable to CTAC's high ionic strength can negate the benefits, despite the absence of CTAC precipitation. This underscores the delicate balance between enhancing chemiluminescence and avoiding ionic strength-induced quenching effects.

The interaction between chloride ions and Triton X-100 reveals a diminished enhancing effect of chloride ions on RCL compared to CTAC. Here, the presence of Triton X-100 seems to limit the potential of chloride ions added to the first reagent from acting as effective enhancers during the chemiluminescence reaction. This indicates that the surfactant's characteristics can interfere with or modulate the enhancing role of chloride ions, highlighting the complexity of surfactant-ion interactions in chemiluminescence.

The scenario with SDS further complicates the chloride ion effect due to the strong salting-out phenomenon induced by excess chloride ions, leading to immediate white precipitation and significant RCL quenching. This observation delineates a constrained efficacy window for chloride ion concentration in the presence of SDS, emphasizing the critical balance needed between achieving optimal chemiluminescence enhancement and avoiding the counterproductive salting-out effect.

In this method, a sample volume of 25 μl, either with or without acridinium ester-labeled immunocomplexes, can be combined with 100 μl of the first reagent containing graphene oxide (GO). This mixture can be then incubated for 20 seconds in a borosilicate test tube to ensure uniform dispersion of the acridinium ester-labeled immunocomplexes. Following this incubation, 300 μl of the second reagent can be added to the test tube for immediate chemiluminescence measurement, which can be conducted over either 5 or 15 seconds. The measurement duration for the addition of the second reagent, when it contained cationic or neutral surfactants, can be 5 seconds. Conversely, when the second reagent included an anionic surfactant, the relative chemiluminescence intensity can be measured over a 15-second period immediately after its addition.

According to another embodiment of the present disclosure, a method of detecting a target antigen in a sample using the above described first and second reagents is provided. The method can include various immunoassay techniques using acridinium ester chemiluminescence, for example, sandwich immune assay, indirect competitive immunoassay and direct competitive immunoassay. For the sandwich immunoassay and indirect competitive immunoassay, an immunoreaction can be performed between a target antigen in a sample and a detection antibody-conjugated acridinium ester, which forms an acridinium ester-labeled immunocomplex. For the direct competitive immunoassay, the immunoreaction is performed between the target antigen and an artificial antigen-conjugated acridinium ester to form an acridinium ester-labeled immune complex. The artificial antigen can be consistent with (or the same as) the target antigen. After performing the immunoreaction, the acridinium ester-labeled immunocomplex can be dispersed in the first reagent comprising an acid, hydrogen peroxide and a graphene-based material. And then, a second reagent including a base and a surfactant can be added into the dispersed acridinium ester-labeled immunocomplex to emit chemiluminescence signal, and an intensity of the chemiluminescence signal is measured.

In the dispersing step, the acridinium ester-labeled immunocomplex and the first reagent can be mixed and incubated for less than 5 minutes, less than 3 minutes, less than 1.5 minutes, or less than 50 seconds.

The sample can be selected from the group consisting of serum, plasma, whole blood, stool, cerebrospinal fluid, synovial fluid, tissue, nasal swabs, and urine from humans or animals. The sample also can be selected from the group consisting of drinking water, tap water, vegetables, fruit, meat, and contaminated materials.

The target antigen can be an antigen derived from bacteria, cells, foodborne pathogens, peptides, proteins, haptens, or viruses. The target antigen also can be small molecule antigens, non-protein antigens, cyclic antigens, scarce antigens, single epitope antigens, or obscured epitope antigens. According to an embodiment of the present disclosure, the target antigen can be a target material or a target analyte. However, the type of the target antigen is not limited thereto.

In the above-described method, the step of measuring the intensity of the chemiluminescence signal can be performed less than 20 seconds, less than 10 seconds, or 5 seconds, after adding the second reagent.

Hereinafter, preferred examples of the present disclosure, comparative examples compared thereto, and test examples for evaluating the examples are described. However, it will be apparent to those skilled in the art that these examples are merely illustrative of the present disclosure, and various changes and modifications can be made within the scope and technical spirit of the present disclosure, and it goes without saying that such variations and modifications fall within the scope of the appended claims.

### EXAMPLES

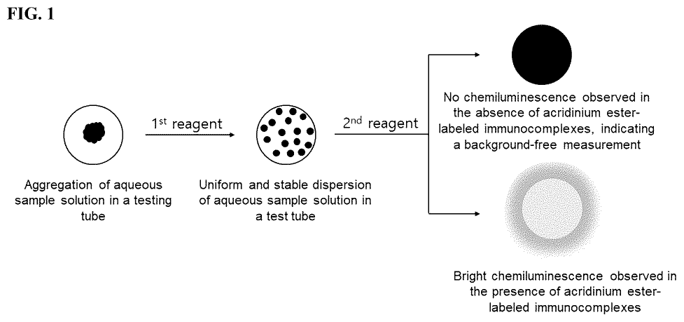

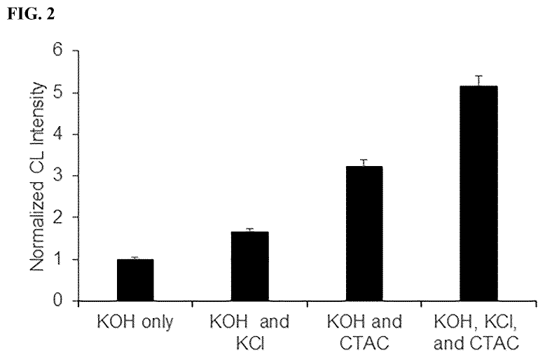

Acridinium ester chemiluminescence is induced by sequentially adding the first and second reagents to a test tube containing acridinium ester-labeled immunocomplexes as shown in FIG. 1. The intensity of the chemiluminescence is influenced by the concentration and properties of the components within these reagents. Furthermore, the relative chemiluminescence intensity is affected by the incubation period required for the thorough dispersion and stabilization of the acridinium ester-labeled immunocomplexes following the introduction of the first reagent. The maximum chemiluminescence intensity and the decay time of the chemiluminescence signal are also determined by the characteristics of the surfactant and the strong base in the second reagent.

Graphene oxide (GO) aqueous dispersion at 5 mg/ml, sourced from Goographene in Merrifield, VA, was evaluated at various concentrations to identify the optimal conditions for enhancing acridinium ester chemiluminescence and controlling background generated in the absence of acridinium ester-labeled immunocomplexes. Monoclonal CEA antibodies (anti-CEA) were procured from Fitzgerald Industries International in Acton, MA. Anti-CEA antibodies conjugated to acridinium ester at a concentration of 1 mg/ml were produced through a 30-minute reaction between anti-CEA antibodies and Acridinium NHS ester, supplied by Cayman Chemical in Ann Arbor, MI, conducted at room temperature. The resultant conjugate, suspended in a storage buffer from Dojindo, Rockville, MD, was then refrigerated as a stock solution. This stock was further diluted with PBS buffer (pH 7.4) to generate control samples for experimental use.

For the assay, 25 μl of the control sample was placed into a borosilicate tube within the detection cell of a Lumat 9507 luminometer (Berthold Inc.), which is equipped with dual syringe pumps for reagent delivery. The first reagent, 100 μl, was administered using the first pump, followed by a 20-second incubation. Subsequently, 300 μl of the second reagent was injected via the second pump, and the chemiluminescence was recorded by the luminometer for either 5 or 15 seconds.

### Example 1. Role of Graphene Oxide in Acridinium Ester Chemiluminescence Reaction in Chemiluminescence Immunoassays (CLIAs)

TABLE 1
Concentration effect of GO in acridinium ester chemiluminescence reaction.

| | Components | GO (μg/ml) | Background¹ | RCL² |
|---|---|---|---|---|
| Case 1 | 1^{st} reagent: [H₂O₂] = 20 mM, [Citric acid] = 4 mM | 2 | 0 | 5,204 |
| | 2^{nd} reagent: [KOH] = 100 mM, | 4 | 0 | 5,966 |
| | [Triton X-100] = 0.25% | 8 | 0 | 6,142 |
| Case 2 | 1^{st} reagent: [H₂O₂] = 20 mM, [Citric acid] = 4 mM | 2 | 0 | 6,472 |
| | 2^{nd} reagent: [KOH] = 50 mM, [Triton X-100] = 1.5% | 4 | 0 | 7,327 |
| | | 8 | 69 | 7,478 |

^{1, 2}Background levels and Relative Chemiluminescence Intensity (RCL) for each experimental condition were measured five times to ensure consistency and reliability of the data (Standard deviation: <5.0%).

Table 1 demonstrates that the relative chemiluminescence intensity (RCL) increases with the addition of graphene oxide (GO), highlighting GO's role in enhancing RCL without generating background noise. Specifically, Case 1 presents evidence that RCL is augmented as GO concentrations rise from 2 to 8 μg/ml, establishing GO as a potent enhancer of chemiluminescence. Conversely, Case 2 reveals that a GO concentration as high as 8 μg/ml introduces a low level of background, even though the RCL remains comparable to that observed with 6 μg/ml of GO. Therefore, Table 1 suggests that background levels can be detected at higher GO concentrations, influenced by the specific compositions and concentrations of components in both the first and second reagents. Moreover, Table 1 shows the ability of a background-free analysis system to accurately quantify trace levels of acridinium ester-labeled immunocomplexes, emphasizing the system's precision and effectiveness in sensitive detection.

TABLE 2
Interaction between GO and a surfactant in acridinium ester chemiluminescence reaction.

| Components | Surfactant¹ | Background² | RCL³ |
|---|---|---|---|
| 1^{st} reagent: [GO] = 8 μg/ml, [H₂O₂] = 20 mM, | [CTAC] = 7 mM | 40 | 4,125 |
| [Citric acid] = 4 mM | [Triton X-100] = 0.25% | 0 | 5,432 |
| | [Tween 20] = 0.25% | 115 | 3,712 |
| 2^{nd} reagent: [NaOH] = 100 mM | [SDS] = 30 mM | 0 | 5,087 |

¹Each surfactant was mixed with NaOH in the second reagent.
^{2, 3}Background levels and Relative Chemiluminescence Intensity (RCL) for each experimental condition were measured five times to ensure consistency and reliability of the data (Standard deviation: <5.0%).

Table 2 elucidates that both Relative Chemiluminescence Intensity (RCL) and background levels are influenced by the type of surfactant combined with NaOH in the second reagent. Notably, no background was detected in samples not containing acridinium ester-labeled immunocomplexes when Triton X-100 or SDS were used, whereas a measurable background was observed with the addition of CTAC or Tween 20. Furthermore, the RCL varied depending on the surfactant used, with Triton X-100 or SDS yielding higher RCL compared to CTAC or Tween 20.

Therefore, combining the insights from Tables 1 and 2, it becomes evident that background generation can result from the interaction between GO and a surfactant or can be attributed to the inherent properties of the surfactant itself. This highlights the critical role that both graphene oxide and surfactant types play in optimizing chemiluminescence-based detection systems, impacting both the sensitivity and specificity of the assay.

TABLE 3
Comparison of conventional first reagent and advance first
reagent with GO according to the present disclosure

| 1^{st} reagent | 2^{nd} reagent¹ | Background (B)² | RCL³ | RCL/B |
|---|---|---|---|---|
| Conventional: [HNO₃] = 11.8 mM, , | [NaOH] = 347 mM, | 5,963 | 25,328 | 4.24 |
| [H₂O₂] = 1.32% (1,340 mM) | [Triton X-100] = 2% | | | |
| Advanced: [GO] = 4 μg/ml, [H₂O₂] = | | 1,139 | 26,898 | 23.62 |
| 20 mM, [Citric acid] = 8 mM | | | | |

¹The second reagent to be used with the conventional first reagent in acridinium ester chemiluminescence reaction.
^{2, 3}Background levels and Relative Chemiluminescence Intensity (RCL) for each experimental condition were measured five times to ensure consistency and reliability of the data (Standard deviation: <5.0%).

Table 3 highlights the multifaceted roles of GO when incorporated into an advanced first reagent (the first reagent according to the present disclosure) for the acridinium ester chemiluminescence reaction. Primarily, GO significantly reduces background noise, achieving a background level approximately 5.2 times lower than that observed with conventional first reagents. This demonstrates GO's capability as a background inhibitor, effectively minimizing or preventing the generation of background in the absence of acridinium ester-labeled immunocomplexes. This property is crucial for enhancing the specificity and sensitivity of the detection system by ensuring that the signal observed is predominantly due to the presence of the target analyte.

Moreover, GO serves as a potent enhancer of RCL, particularly in the presence of acridinium ester-labeled immunocomplexes. The improved RCL to background ratio (RCL/B=23.62) with the advanced first reagent containing GO, compared to the ratio obtained with the conventional reagent (RCL/B=4.24), underscores GO's effectiveness in boosting signal intensity while simultaneously suppressing background levels. This dual role enhances the assay's overall dynamic range, allowing for more precise quantification of the target.

Additionally, the concentration of H₂O₂ in the advanced first reagent (the first reagent according to the present disclosure) is markedly reduced, by a factor of 67, compared to the conventional first reagent. Despite this significant reduction, the RCL observed with the advanced reagent is higher, indicating that GO not only compensates for the lower H₂O₂ concentration but may also amplify its oxidative effects. This suggests that GO can act as an oxidative agent or supporter, enhancing the efficiency of H₂O₂ in the chemiluminescence reaction.

In essence, GO's inclusion in the acridinium ester chemiluminescence reaction system introduces a synergistic effect that encompasses background inhibition, signal enhancement, and efficient use of H₂O₂. This tripartite functionality of GO not only improves the assay's performance by increasing sensitivity and specificity but also makes the system more environmentally friendly and cost-effective by reducing the reliance on high concentrations of reactive chemicals. The incorporation of GO thus represents a significant advancement in the development of chemiluminescence-based detection systems, offering a more refined approach to the quantification of immunocomplexes.

### Example 2. Effect of H₂O₂ Concentration in Acridinium Ester Chemiluminescence Reaction in CLIAs

Chemiluminescence immunoassays (CLIAs) were performed as in Example 1 except for the condition described in Table 4, and the background levels and the relative chemiluminescence intensity were measured by the luminometer.

TABLE 4
Effect of H₂O₂ concentration in acridinium ester chemiluminescence reaction

| Components | H₂O₂, mM | Background¹ | RCL² |
|---|---|---|---|
| 1^{st} reagent: [GO] = 8 μg/ml, [Citric acid] = 4 mM | 5 | 0 | 2,404 |
| | 10 | 0 | 2,522 |
| | 15 | 0 | 2,843 |
| 2^{nd} reagent: [NaOH] = 100 mM, [Triton X-100] = 1% | 20 | 0 | 2,681 |
| | 200 | 0 | 2,359 |

^{1, 2}Background levels and Relative Chemiluminescence Intensity (RCL) for each experimental condition were measured five times to ensure consistency and reliability of the data (Standard deviation: <5.0%).

The data presented in Table 4 highlight the efficacy of using GO in the first reagent to enable the analysis of trace levels of targets with significantly lower concentrations of H₂O₂ than those required by conventional first reagents. This efficiency is attributed to GO's role as an oxidative agent or supporter, which amplifies the effectiveness of H₂O₂ in the acridinium ester chemiluminescence reaction. Interestingly, the experiments documented no background interference across a broad range of H₂O₂ concentrations (5-200 mM), suggesting that H₂O₂, in the context of this optimized system, does not contribute to background noise in the absence of the target analyte. This finding is crucial for the specificity of the detection method, as it indicates that the presence of H₂O₂ does not lead to false signals unrelated to the target's presence.

Furthermore, the determination that 15 mM of H₂O₂ serves as an optimal concentration for quantifying trace targets underscores the precision with which the components of the chemiluminescence detection system can be balanced to achieve high sensitivity and specificity. This concentration represents a harmonious balance between ensuring sufficient oxidative potential for the reaction and maintaining a minimal background level, thereby enhancing the system's overall efficiency.

Adding to these observations, the role of GO in this system exemplifies a significant advancement in biochemical analysis techniques. By facilitating the use of lower concentrations of reactive substances like H₂O₂, GO not only improves the environmental footprint of the detection method but also potentially reduces costs and enhances safety by lowering the reliance on high concentrations of reactive chemicals. Moreover, the ability of this system to function effectively without background generation across a wide range of H₂O₂ concentrations further demonstrates its robustness and reliability for clinical and research applications, offering a promising approach for the sensitive detection of trace biomolecules.

### Example 3. Effect of Acids in Acridinium Ester Chemiluminescence Reaction in CLIAs

Chemiluminescence immunoassays (CLIAs) were performed as in Example 1 except for the condition described in Tables 5 and 6, and the background levels and the relative chemiluminescence intensity were measured by the luminometer.

TABLE 5
Effect of strong and weak acids in acridinium ester chemiluminescence reaction

| | [Acid] | Background¹ | RCL² |
|---|---|---|---|
| 1^{st} reagent: [GO] = 2 μg/ml, [H₂O₂] = 15 mM, | Acetic acid | 0 | 5,156 |
| [Acid] = 12 mM | Ascorbic acid | 0 | 4,996 |
| | Citric acid | 0 | 5,397 |
| 2^{nd} reagent: [KOH] = 100 mM, | HCl | 0 | 4,838 |
| [Triton X-100] = 0.25% | HNO3 | 0 | 5,177 |
| | Oxalic acid | 0 | 5,288 |

^{1, 2}Background levels and Relative Chemiluminescence Intensity (RCL) for each experimental condition were measured five times to ensure consistency and reliability of the data (Standard deviation: <5.0%).

Table 5 illustrates that a background-free analysis system for acridinium ester chemiluminescence detection is adaptable to the inclusion of various types of acids, both strong and weak, within the first reagent. This flexibility is due to the neutralizing effect of the second reagent, which contains 100 mM of a strong base such as NaOH or KOH, effectively counteracting 12 mM of any acid used. Despite this capability for neutralization, the relative chemiluminescence intensity (RCL) observed in the presence of different acids varies slightly. This variation is attributed to the minor differences in the pH of each mixture after neutralization, as the excess strong base interacts with each acid type uniquely, resulting in slightly distinct pH levels.

The findings from Table 5 convey a significant advantage of the detection system: the ability to utilize any acid in the formulation of the first reagent without compromising the system's effectiveness or introducing background noise. This adaptability enhances the system's versatility, allowing for customization based on the availability of reagents or specific requirements of the assay being performed.

Moreover, the slight differences in RCL due to the acid used highlight the importance of fine-tuning the assay conditions to optimize performance. Although these differences are minor, they underscore the nuanced role that pH adjustments play in maximizing chemiluminescence efficiency. In essence, the capability to employ a range of acids without affecting the background-free nature of the analysis system opens up possibilities for broad applications in clinical diagnostics and research, providing a robust and flexible approach to sensitive and specific detection of target molecules.

TABLE 6
Effect of citric acid concentration in acridinium ester chemiluminescence reaction

| | Citric acid, mM | Background¹ | RCL² |
|---|---|---|---|
| 1^{st} reagent: [GO] = 4 μg/ml, [H₂O₂] = 20 mM, | 1 | 0 | 1,992 |
| [Acid] = 1, 4, 8, or 16 mM | 4 | 0 | 2,601 |
| 2^{nd} reagent: [KOH] = 50 mM, | 8 | 0 | 2,987 |
| [Triton X-100] = 1% | 16 | 0 | 2,655 |

^{1, 2}Background levels and Relative Chemiluminescence Intensity (RCL) for each experimental condition were measured five times to ensure consistency and reliability of the data (Standard deviation: <5.0%).

Table 6 reveals that RCL exhibits a slight dependency on the concentration of citric acid, ranging from 1 to 16 mM, in the first reagent. This dependency is attributed to the minor variations in the pH of the final solution, resulting from the mixture of the first and second reagents, with each concentration of citric acid yielding a slightly different final pH level. Notably, the background levels remained unaffected by changes in citric acid concentration, suggesting that low concentrations of acid, which are fully neutralizable by the high concentrations of a strong base in the second reagent, do not significantly contribute to background generation.

The findings from Table 6 underscore that the main factor influencing background presence is not the low concentration of acid but rather the balance between the acid and the strong base concentrations. This balance is critical for ensuring that the final solution's pH is optimized for the chemiluminescence reaction without introducing background noise. Consequently, the optimal concentration of citric acid within the first reagent is determined by the concentration of the strong base present in the second reagent, highlighting the importance of carefully calibrating the reagent compositions to achieve the desired assay performance.

These results emphasize the interplay between the components of the first and second reagents in the chemiluminescence detection system. By fine-tuning the concentrations of citric acid and the strong base, researchers and clinicians can optimize the detection system for sensitive and specific measurement of target analytes, ensuring that the assay conditions are ideally suited for maximizing RCL while maintaining a background-free environment. This capability for precise adjustment enhances the system's utility across a wide range of applications, offering a robust framework for the development of highly sensitive diagnostic assays. For example, as acid concentrations increase, there should be a corresponding increase in the concentration of the strong base to preserve the pH balance necessary for generating a strong RCL with no background.

### Example 4. Effect of Strong Base in Acridinium Ester Chemiluminescence Reaction in CLIAs

Chemiluminescence immunoassays (CLIAs) were performed as in Example 1 except for the condition described in Tables 7 and 8, and the background levels and the relative chemiluminescence intensity were measured by the luminometer.

TABLE 7
Concentration effect of KOH in acridinium ester chemiluminescence reaction

| | KOH, mM | Background¹ | RCL² |
|---|---|---|---|
| 1^{st} reagent: [GO] = 1 μg/ml, [H₂O₂] = 15 mM, | 20 | 185 | 4,583 |
| [Citric acid] = 12 mM | 30 | 112 | 5,160 |
| 2^{nd} reagent: [KOH] = 20, 30, 50, or 100 mM | 50 | 10 | 5,543 |
| [CTAC] = 20 mM | 100 | 0 | 5,521 |

^{1, 2}Background levels and Relative Chemiluminescence Intensity (RCL) for each experimental condition were measured five times to ensure consistency and reliability of the data (Standard deviation: <5.0%).

Table 7 illustrates that the background, measured without acridinium ester-labeled immunocomplexes, diminishes as the concentration of KOH increases. Notably, the background is completely eliminated upon the incorporation of 100 mM KOH into the second reagent alongside 20 mM CTAC, suggesting that the background's formation is closely tied to the pH of the final mixture, which includes the sample and both reagents, modulated by the KOH levels. No background was observed when the second reagent's KOH concentration exceeded 100 mM.

Furthermore, Table 7 highlights that RCL is influenced by KOH concentration. An enhancement in RCL was observed with increasing KOH concentrations from 20 to 50 mM, attributed to reaching the optimal pH conducive to the brightest chemiluminescence emission. The RCL at 50 mM KOH was statistically comparable to that at 100 mM, indicating a broad pH range within which maximum RCL is achievable. For instance, RCL values at 200 mM KOH were similar to those at 100 mM, demonstrating the wide effective pH range for maximal chemiluminescence.

The findings from Table 7 underscore the flexibility in designing a background-free analysis system for acridinium ester chemiluminescence detection by adjusting the KOH (or NaOH) concentration. Specifically, 100 mM KOH emerges as optimal within the system outlined in Table 7, offering an effective strategy for achieving precise and reliable measurements without background interference. This adaptability in controlling KOH or NaOH concentrations facilitates the customization of the detection system to suit various analytical needs, enhancing the method's applicability and performance in sensitive and specific target quantification.

TABLE 8
Comparison of KOH and tetra n-propylammonium hydroxide
(TPA) in acridinium ester chemiluminescence

| 1^{st} reagent | 2^{nd} reagent | Background¹ | RCL² |
|---|---|---|---|
| [GO] = 1 μg/ml, [H₂O₂] = 15 mM, | [KOH] = 100 mM, [Triton X-100] = 0.5% | 129 | 5,935 |
| [Citric acid] = 12 mM | [TPA] = 40 mM, [Triton X-100] = 0.5% | 0 | 7,477 |

^{1, 2}Background levels and Relative Chemiluminescence Intensity (RCL) for each experimental condition were measured five times to ensure consistency and reliability of the data (Standard deviation: <5.0%).

Table 8 reveals that RCL is higher when 40 mM TPA is used in the second reagent with 0.5% Triton X-100, compared to the RCL achieved with 100 mM KOH. Notably, background was absent in the former condition but present in the latter. Drawing from the insights provided in Table 7, these observations suggest that the final solution's pH, when adjusted with 40 mM TPA, falls within the optimal pH range conducive to achieving the brightest RCL. In contrast, the solution pH adjusted with 100 mM KOH falls below the optimal pH threshold for maximum RCL. Furthermore, the emergence of background with the addition of 100 mM KOH has been shown to vary depending on the type of surfactants used.

These findings underscore the critical role of pH in optimizing chemiluminescence reactions and highlight the importance of selecting the appropriate base and surfactant concentrations to achieve the best possible assay performance. The absence of background under certain conditions further emphasizes the need for precise formulation of the reagent mix to ensure high sensitivity and specificity in the detection of target analytes. This tailored approach to reagent composition, particularly the careful adjustment of pH and surfactant type, offers significant advantages in enhancing the accuracy and reliability of acridinium ester chemiluminescence-based detection systems.

### Example 5. Effect of Surfactants in Acridinium Ester Chemiluminescence Reaction in CLIAs

Chemiluminescence immunoassays (CLIAs) were performed as in Example 1 except for the condition described in Tables 9 to 11, and the background levels and the relative chemiluminescence intensity were measured by the luminometer.

TABLE 9
Effect of CTAC concentration in acridinium ester chemiluminescence reaction

| | CTAC, mM | Background¹ | RCL² |
|---|---|---|---|
| 1^{st} reagent: [GO] = 1 μg/ml, [H₂O₂] = 10 mM, | 20 | 0 | 5,556 |
| [Citric acid] = 12 mM | 30 | 0 | 6,398 |
| 2^{nd} reagent: [KOH] = 100 mM | 40 | 0 | 6.850 |
| [CTAC] = 20, 30, 40, 50 mM | 50 | 0 | 6,671 |

^{1, 2}Background levels and Relative Chemiluminescence Intensity (RCL) for each experimental condition were measured five times to ensure consistency and reliability of the data (Standard deviation: <5.0%).

Table 9 demonstrates that RCL increases as the concentration of CTAC is elevated from 20 mM to 40 mM, after which the RCL observed at 50 mM is statistically equivalent to that at 40 mM. Importantly, no background noise was detected across the CTAC concentration range of 20 to 50 mM. This indicates that the final solution's pH, adjusted by adding 100 mM KOH in the second reagent containing CTAC, falls within the optimal range for achieving maximum RCL without generating background interference.

Cetyltrimethylammonium bromide (CTAB), another cationic surfactant, was also found to be effective as an enhancer in the acridinium ester chemiluminescence reaction, albeit with a lower enhancing effect compared to CTAC. For instance, the RCL with 20 mM CTAB was about 70% of that observed with 20 mM CTAC, yet CTAB did not lead to background generation, underscoring its suitability under the optimal pH conditions.

The findings suggest that a background-free analysis system for acridinium ester chemiluminescence detection can be versatilely configured using a variety of cationic surfactants, including CTAC, CTAB, didecyldimethylammonium chloride (DDAC), and tetraethylammonium bromide (TEAB), provided they are dissolved in an appropriate aqueous solution. The choice of surfactant and its concentration can be tailored to optimize the chemiluminescence signal while maintaining a background-free environment, highlighting the system's adaptability to different reagent formulations, and enhancing the sensitivity and specificity of the detection method. This flexibility allows for the fine-tuning of assay conditions to maximize the efficacy of acridinium ester chemiluminescence detection across a range of analytical applications.

TABLE 10
Effect of CTAC in acridinium ester chemiluminescence

| | Storage Duration | | | |
|---|---|---|---|---|
| 1^{st} and 2^{nd} reagent | for reagents¹ | | Background² | RCL³ |
| 1^{st} reagent: [GO] = 4 μg/ml, [H₂O₂] = 15 mM, | No storage | | 562 | 6,964 |
| [Citric acid] = 8 mM | 1 | day | 84 | 6,438 |
| 2^{nd} reagent: [KOH] = 100 mM | 2 | days | 0 | 6,369 |
| [Triton X-100] = 2% | 4 | weeks | 0 | 6,376 |

¹1^{st} and 2^{nd} reagents were stored at room temperature.
^{2, 3}Background levels and Relative Chemiluminescence Intensity (RCL) for each experimental condition were measured five times to ensure consistency and reliability of the data (Standard deviation: <5.0%).

Table 10 reveals that the highest background levels were observed when measurements were conducted with first and second reagents prepared immediately. The background levels dropped significantly one day after preparation, compared to the initial measurements, and completely disappeared after two days or more of storage. This pattern suggests that the background is primarily due to the hydration reaction between Triton X-100 and KOH in the second reagent. By the two-day mark, the product of this hydration reaction is present in insufficient quantities to produce a noticeable background, indicating that the reaction stabilizes over time.

Interestingly, the RCL recorded with freshly prepared reagents was higher than that measured after some storage time because the initial RCL measurements include both the background and the actual signal. After a two-day storage period, allowing for background-free conditions, the RCL becomes consistent and statistically similar even after four weeks of storage. This demonstrates that the analysis system reaches a stable, background-free state at least two days post-preparation and maintains its accuracy and precision for up to four weeks.

The occurrence of a hydration reaction between Triton X-100 and various strong bases (e.g., NaOH, TEA, TPA, TBA) was noted as a cause for the initial measurable background. The duration required to eliminate this background is influenced by the concentration of Triton X-100 and the specific strong base used.

Furthermore, all Triton X derivatives (e.g., Triton X-45, Triton X-100, Triton X-114, Triton X-405, Triton X-705) were found suitable for creating a background-free analysis system for acridinium ester chemiluminescence detection after appropriate storage of the second reagent containing a Triton X derivative and a strong base. Similarly, Tween derivatives (e.g., Tween 20, Tween 40, Tween 60, Tween 80), serving as alternative neutral surfactants, were also effective in developing background-free analysis systems. This broadens the range of surfactants that can be employed, offering flexibility in the formulation of reagents for specific detection requirements.

TABLE 11
Effect of SDS concentration in acridinium ester chemiluminescence reaction

| | SDS, mM | Background¹ | RCL² |
|---|---|---|---|
| 1^{st} reagent: [GO] = 2 μg/ml, [H₂O₂] = 10 mM, | 10 | 0 | 6,256 |
| [Oxalic acid] = 12 mM | 20 | 0 | 7,624 |
| 2^{nd} reagent: [TPA] = 40 mM | 30 | 0 | 8.815 |
| [SDS] = 20, 30, 40, 50 mM | 50 | 0 | 8,611 |

^{1, 2}Background levels and Relative Chemiluminescence Intensity (RCL) for each experimental condition were measured five times to ensure consistency and reliability of the data (Standard deviation: <5.0%).

Table 11 illustrates that no background was detected when SDS, ranging from 10 to 50 mM, in the freshly prepared second reagent was added, similar to observations with cationic surfactants such as CTAC and CTAB. This suggests that the pH of the final solution remains unaffected by the presence of SDS, indicating the feasibility of using a freshly prepared second reagent containing SDS for a background-free acridinium ester chemiluminescence detection system. Additionally, ammonium dodecyl sulfate (ADS), another anionic surfactant, was also found suitable for creating a background-free analysis system.

Furthermore, Table 11 demonstrates that RCL increases with the concentration of SDS up to 30 mM, beyond which the RCL plateaus, as indicated by the RCL at 30 mM being statistically equivalent to that at 50 mM within a ±5% error margin. This finding suggests an optimal concentration of SDS for maximizing RCL without contributing to background noise. Despite the lower RCL observed with ADS compared to SDS, the ability to operate a background-free system with the inclusion of ADS in the second reagent was confirmed.

These results highlight the potential of using anionic surfactants such as SDS and ADS in the formulation of the second reagent for acridinium ester chemiluminescence detection systems. The absence of background with these surfactants, even in freshly prepared reagents, underlines their compatibility and effectiveness in enhancing the assay's sensitivity and specificity. The operational flexibility provided by these surfactants, allowing for immediate use without the need for extended storage to mitigate background, represents a significant advantage in streamlining laboratory workflows and improving the reliability of chemiluminescence-based assays.

### Example 6 Effect of Chloride Ions Added in the Second Reagent for Acridinium Ester Chemiluminescence Reaction in CLIAs

Chemiluminescence immunoassays (CLIAs) were performed as in Example 1 except for the condition described in Table 12, and the background levels and the relative chemiluminescence intensity were measured by the luminometer.

FIG. 2 demonstrates that KCl acts as an enhancer in the acridinium ester chemiluminescence reaction, increasing the chemiluminescence intensity by approximately 67% compared to the intensity observed with KOH alone. Furthermore, the chemiluminescence intensity significantly increased with the addition of the second reagent comprised of KOH, KCl, and CTAC, attributing to the synergistic effect between the two enhancers, KCl and CTAC. Consequently, the chemiluminescence intensity with the combination of KOH, KCl, and CTAC was about 1.6 times higher than that achieved with KOH and CTAC alone.

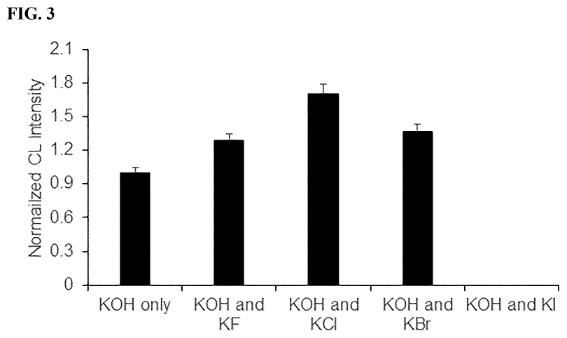

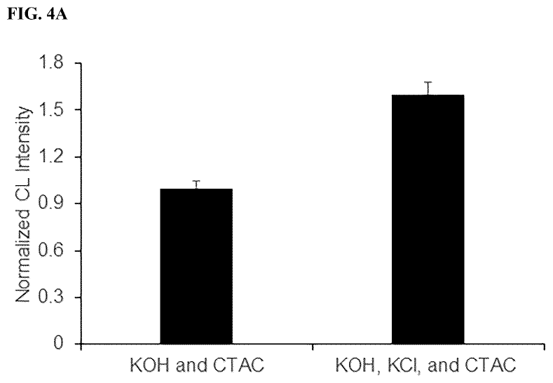

FIG. 3 demonstrates that F⁻, Cl⁻, and Br⁻ ions serve as enhancers in the acridinium ester chemiluminescence reaction, whereas I⁻ functions as a potent quencher of the reaction. Among these, Cl⁻ was identified as the most effective enhancer, surpassing both F⁻ and Br⁻ in its ability to boost the chemiluminescence intensity. This variance in the effect of halogen ions highlights the significant role that the chemical nature of the ions plays in the chemiluminescence mechanism.

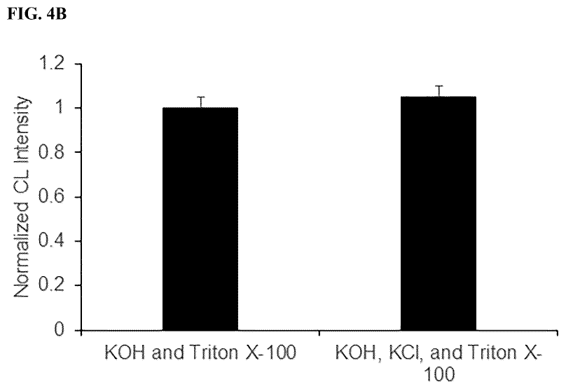

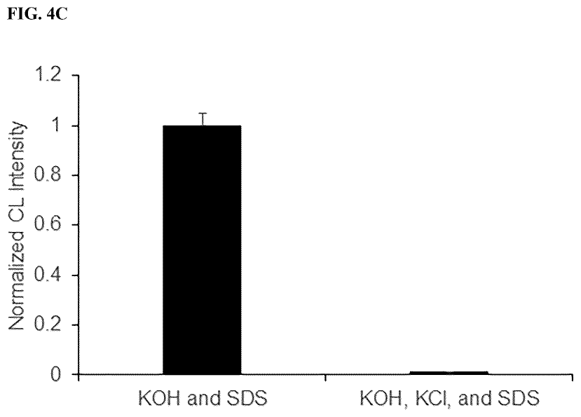

FIG. 4A demonstrates that the inclusion of Cl⁻ via KCl in the second reagent significantly enhances chemiluminescence, boosting intensity by about 60% relative to the second reagent formulation without KCl. This highlights Cl⁻'s role as a potent enhancer in the chemiluminescence reaction.

FIG. 4B reveals that the presence of KCl in a second reagent mixture containing KOH and Triton X-100, a neutral surfactant, does not markedly influence chemiluminescence intensity. This suggests that the enhancing effect of KCl is not universal across all surfactant types, particularly with neutral surfactants like Triton X-100.

FIG. 4C indicates a significant decrease in chemiluminescence when KCl is added to the second reagent alongside SDS, suggesting that excessive KCl can act as an inhibitor, likely due to the salting-out effect which reduces the solubility of SDS in a 100 mM KOH solution. This effect underscores the intricate balance between ionic strength and surfactant solubility in influencing chemiluminescence outcomes.

The collective findings from FIGS. 4A to 4C suggest a strategic approach to using KCl, particularly in conjunction with cationic surfactants such as CTAC and CTAB, to optimize the sensitivity of acridinium ester chemiluminescence reactions. This understanding of how different components interact within the chemiluminescence detection system is crucial for fine-tuning assay conditions to achieve enhanced sensitivity and specificity.

TABLE 12
Effect of chloride ions in acridinium ester chemiluminescence reaction

| | KCl, M | Background¹ | RCL² |
|---|---|---|---|
| 1^{st} reagent: [GO] = 1 μg/ml, [H₂O₂] = 15 mM, | 0.6 | 0 | 14,083 |
| [Citric acid] = 12 mM | 0.9 | 0 | 14,920 |
| 2^{nd} reagent: [TPA] = 40 mM, [CTAC] = 30 mM, | 1.2 | 0 | 15,232 |
| [KCl] = 0.6, 0.9, 1.2, or 1.5M | 1.5 | 0 | 15,378 |

^{1, 2}Background levels and Relative Chemiluminescence Intensity (RCL) for each experimental condition were measured five times to ensure consistency and reliability of the data (Standard deviation: <5.0%).

Table 12 indicates that the presence of excess KCl, ranging from 0.6 to 1.5 M, added to the second reagent does not influence the background levels. This observation suggests that background generation in the chemiluminescence detection system is not directly related to the ionic strength of the final mixture comprising the sample, and both the first and second reagents. Furthermore, Table 12 reveals an enhancement in RCL with increasing concentrations of KCl in the second reagent, peaking at 1.2 M. The RCL observed with the addition of 1.5 M KCl was found to be equivalent to that achieved with 1.2 M KCl, indicating a plateau in the enhancement effect. Notably, the RCL at 1.2 M KCl was only 8% higher than at 0.6 M KCl, highlighting a modest increase in chemiluminescence intensity with higher KCl concentrations. These findings underscore that the optimal concentration of KCl for maximizing RCL in a background-free analysis system is contingent upon the specific composition of the first and second reagents.

The results from Table 12 emphasize the importance of carefully balancing the concentrations of all components within the chemiluminescence detection system to optimize performance. Specifically, they highlight the need for precise calibration of KCl concentration to enhance RCL without contributing to background noise, demonstrating the interplay between ionic strength and chemiluminescence outcomes. This understanding is critical for developing highly sensitive and specific assays, enabling accurate quantification of analytes in various sample matrices.

### Example 7 Effect of Chloride Ions Added in the First Reagent for Acridinium Ester Chemiluminescence Reaction in CLIAs

Chemiluminescence immunoassays (CLIAs) were performed as in Example 1 except for the condition described in Tables 13 and 14, and the background levels and the relative chemiluminescence intensity were measured by the luminometer.

TABLE 13
Effect of buffer containing acridinium ester-labeled immunocomplexes as a control or a sample

| | Buffer (pH 7.5, 10 mM) | Background¹ | RCL² |
|---|---|---|---|
| 1^{st} reagent: [GO] = 1 μg/ml, [H₂O₂] = 15 mM, | Sodium phosphate | 0 | 4,686 |
| [Citric acid] = 12 mM | PBS | 0 | 5,104 |
| 2^{nd} reagent: [KOH] = 100 mM, [CTAC] = 30 mM | Tris-HCl | 0 | 5,205 |
| | TBS | 0 | 6,176 |

^{1, 2}Background levels and Relative Chemiluminescence Intensity (RCL) for each experimental condition were measured five times to ensure consistency and reliability of the data (Standard deviation: <5.0%).

As shown in Table 13, RCL in acridinium ester chemiluminescence reactions is dependent on the types of buffer solution used. The RCL in PBS, which contains approximately 140 mM chloride ions, was about 10% higher than that in sodium phosphate buffer. This indicates that chloride ions in PBS act as enhancers in the acridinium ester chemiluminescence reaction.

Table 13 also suggests that Tris-HCl buffer is more suitable for preparing control samples or test samples compared to sodium phosphate buffer, as the RCL in Tris-HCl is higher than in sodium phosphate. Additionally, the RCL in Tris-Buffered Saline (TBS), which contains 150 mM chloride ions, was the highest among the tested buffers. This is attributed to TBS being composed of Tris-HCl and chloride ions, both of which are capable of enhancing light emitted acridinium ester chemiluminescence reaction.

The findings in Table 13 imply that adding chlorine ions to the first reagent, rather than the second reagent, can also act as an enhancer to improve the intensity of the chemiluminescence.

TABLE 14
Concentration effect of chloride ions in the first reagent
for acridinium ester chemiluminescence reaction

| | [Cl⁻], M¹ | Background² | RCL³ |
|---|---|---|---|
| 1^{st} reagent: [GO] = 1 μg/ml, [H₂O₂] = 15 mM, | 0 | 0 | 38.996 |
| [Citric acid] = 12 mM | 0.15 | 0 | 46,567 |
| [NaCl] = 0, 0.6, 1.2, 1.8, 2.4M | 0.3 | 0 | 54,827 |
| | 0.45 | 0 | 64,425 |
| 2^{nd} reagent: [KOH] = 100 mM, [CTAC] = 30 mM | 0.6 | 0 | 59,675 |

¹The final concentration of chloride ions in the mixture of the first and second reagents is four times lower than the concentration in the first reagent alone, due to the 1:3 volume mixing ratio between the first and second reagents.
^{2, 3}Background levels and Relative Chemiluminescence Intensity (RCL) for each experimental condition were measured five times to ensure consistency and reliability of the data (Standard deviation: <5.0%).

Table 14 demonstrates that RCL is influenced by the concentration of chloride ions in the first reagent. Specifically, an increase in chloride ion concentration up to 1.8 M in the first reagent proportionally enhances RCL. This translates to a proportional enhancement in RCL with chloride ion concentrations up to 0.45 M in the final solution, which is a mixture of the first and second reagents, for acridinium ester chemiluminescence reactions. However, when the concentration of chloride ions reaches 0.6 M in the final solution, RCL decreases compared to the 0.45 M due to the salting-out effect of CTAC in solutions of high ionic strength, even though no precipitation of undissolved CTAC was observed. This reduction in RCL at 0.6 M chloride ions is attributed to the diminished concentration of CTAC, which could otherwise enhance chemiluminescence intensity. Nonetheless, RCL with 0.6 M chloride ions is still approximately 53% higher than in the absence of chloride ions.

According to Table 14, the presence of 0.45 M chloride ions results in an approximately 65% increase in RCL compared to the absence of chloride ions. This significant enhancement suggests that adding chloride ions to the first reagent is more effective than incorporating them into the second reagent, as depicted in FIG. 4(a) and Table 12. The first reagent's primary function is to evenly distribute acridinium ester-labeled immunocomplexes and maintain their stability momentarily before the introduction of the second reagent, which initiates the flash chemiluminescence. Typically, the first reagent fulfills its role within 10 to 60 seconds. Therefore, chloride ions in the first reagent are essential for interacting with acridinium ester-labeled immunocomplexes, enhancing their stability within this critical timeframe. Conversely, chloride ions added through the second reagent lack the opportunity to stabilize the immunocomplexes, as the chemiluminescence reaction occurs immediately upon mixing.

To determine the optimal incubation time for stabilizing acridinium ester-labeled immunocomplexes with the first reagent, RCL was measured at 10-second intervals, ranging from 10 to 60 seconds. The RCL measurements remained constant within a statistically acceptable error margin (±5%). These findings underscore the role of chloride ions in not only rapidly dispersing but also in maintaining the stability of acridinium ester-labeled immunocomplexes effectively.

The data show that chloride ions in the first reagent serve a dual role as enhancers: they expedite the dispersion and stabilization of acridinium ester-labeled immunocomplexes prior to the addition of the second reagent. Moreover, they contribute to the stability of high-energy intermediates formed upon mixing with the second reagent, leading to an enhanced chemiluminescence output.

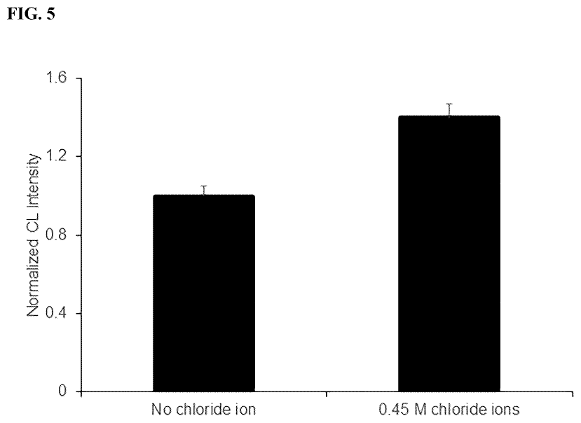

FIG. 5 reveals that RCL, in the presence of 0.45 M chloride ions, shows an approximately 40% increase compared to that without chloride ions when using a second reagent composed of 100 mM NaOH and 2% Triton X-100. This enhancement rate is lower than that observed with the second reagent containing CTAC, as detailed in Table 14. These findings suggest that the effectiveness of chloride ions in enhancing acridinium ester chemiluminescence reactions varies with the type of surfactant present in the second reagent. Furthermore, chloride ions in the first reagent are shown to improve chemiluminescence intensity, in contrast to chloride ions in the second reagent, which do not exhibit an enhancing effect as demonstrated in FIG. 4B. This indicates that chloride ions in the first reagent aid in the dispersion and stabilization of acridinium ester-labeled immunocomplexes during the incubation period of the mixture, which includes the first reagent and a control with the labeled immunocomplexes, prior to the addition of the second reagent containing Triton X-100. The inability of chloride ions in the second reagent to act as enhancers during the short period of flash chemiluminescence emission is attributed to Triton X-100. This surfactant interferes with the role of chloride ions, despite Triton X-100 itself being an enhancer, similarly to CTAC.

Acridinium ester-labeled immunocomplexes in TBS emitted brighter chemiluminescence compared to those in sodium phosphate, PBS, and Tris-HCl, when a second reagent containing an anionic surfactant such as SDS was used. This enhancement is attributed to the synergistic effects of Tris-HCl and chloride ions. Consequently, the addition of chloride ions to the first reagent led to an increase in RCL for the acridinium ester chemiluminescence reaction. However, there was a limited acceptable range for the concentration of chloride ions added to the first reagent, constrained by the potent salting-out effect of SDS in the presence of high levels of chloride ions. This salting-out effect, upon the introduction of chloride ions into the final solution, resulted in immediate white precipitation and a significant quenching of RCL.

What is claimed is:

1. A reagent system for eliciting an acridinium ester chemiluminescence, comprising:
a first reagent including a graphene-based material, hydrogen peroxide and an acid; and
a second reagent including a base and a surfactant,
wherein the graphene-based material is present at a concentration of 0.5 μg/ml or more to 6 μg/ml or less,
wherein the hydrogen peroxide is present at a concentration of 5 to 20 mM, and
wherein the acid is present at a concentration of 1 to 24 mM.

2. The reagent system of claim 1, wherein a background signal of the acridinium ester chemiluminescence measured by a luminometer is either not detected or detected at less than 0.005% of the maximum chemiluminescence intensity measured by the luminometer.

3. The reagent system of claim 1, wherein the graphene-based material is selected from the group consisting of graphene, graphene oxide (GO), and reduced graphene oxide (rGO).

4. The reagent system of claim 1, wherein the acid is selected from the group consisting of nitric acid (HNO₃), hydrochloric acid (HCl), ascorbic acid, citric acid, acetic acid, formic acid, oxalic acid, and a combination thereof.

5. The reagent system of claim 1, wherein the base is selected from the group consisting of sodium hydroxide (NaOH), potassium hydroxide (KOH), sodium carbonate, potassium carbonate, ammonium hydroxide, tetra-n-ethylammonium hydroxide (TEA), tetra-n-propylammonium hydroxide (TPA), tetra-n-butylammonium hydroxide (TBA), and a combination thereof.

6. The reagent system of claim 1, wherein a concentration of the base in the second reagent is less than 200 mM.

7. The reagent system of claim 1, wherein the base is one or more of sodium hydroxide (NaOH) and potassium hydroxide (KOH), and a concentration of the base is 50 mM or more to less than 200 mM.

8. The reagent system of claim 1, wherein the base is one or more of tetra-n-ethylammonium hydroxide (TEA), tetra-n-propylammonium hydroxide (TPA), and tetra-n-butylammonium hydroxide (TBA), and a concentration of the base is 10 mM to 50 mM.

9. The reagent system of claim 1, wherein the surfactant is selected from the group consisting of a cationic surfactant, a neutral surfactant, an anionic surfactant, a non-ionic surfactant and a combination thereof.

10. The reagent system of claim 9, wherein the cationic surfactant is CTAC (cetyltrimethylammonium chloride) or CTAB (cetyltrimethylammonium bromide).

11. The reagent system of claim 1, wherein the surfactant is CTAC (cetyltrimethylammonium chloride) or CTAB (cetyltrimethylammonium bromide), and a concentration of the surfactant is 5 to 50 mM.

12. The reagent system of claim 9, wherein the neutral surfactant is one or more polyethylene glycol tert-octylphenyl ether derivatives and/or polyoxyethylenesorbitan monopalmitate derivatives selected from the group consisting of Triton X-45, Triton X-100, Triton X-114, Triton X-165, Triton X-305, Triton X-405, Triton X-705, Tween 20, Tween 40, Tween 60, and Tween 80.

13. The reagent system of claim 9, wherein the anionic surfactant is ammonium dodecyl sulfate (ADS) or sodium dodecyl sulfate (SDS).

14. The reagent system of claim 1, wherein the surfactant is ammonium dodecyl sulfate (ADS) or sodium dodecyl sulfate (SDS), and a concentration of the surfactant is 5 to 60 mM.

15. The reagent system of claim 9, wherein the non-ionic surfactant comprises one or more of sorbitan monolaurate (SPAN 20) and a cyclodextrin.

16. The reagent system of claim 1, wherein a concentration of the surfactant is 0.1 mM to 100 mM.

17. The reagent system of claim 1, wherein the pH of the second reagent is 12.6 to 13.1.

18. The reagent system of claim 1, wherein the second reagent further comprises an alkali metal salt having a halogen ion of F⁻, Cl⁻ or Br⁻.

19. The reagent system of claim 18, wherein the alkali metal salt is selected from the group consisting of potassium chloride (KCl), sodium chloride (NaCl), cesium chloride (CsCl), sodium bromide (NaBr), potassium bromide (KBr), and sodium fluoride (NaF).

20. The reagent system of claim 1, wherein the first reagent further comprises a chloride ion.

21. A method of detecting a target antigen in a sample, comprising:
performing an immunoreaction between a target antigen in a sample and a detection antibody conjugated with acridinium ester for sandwich immunoassays or an artificial antigen, which is compatible with the target antigen, conjugated with acridinium ester for competitive immunoassays to form an acridinium ester-labeled immunocomplex;
dispersing the acridinium ester-labeled immunocomplex in a first reagent comprising an acid, hydrogen peroxide and a graphene-based material;
adding a second reagent including a base and a surfactant into the dispersed acridinium ester-labeled immunocomplex to emit a chemiluminescence signal; and
measuring an intensity of the chemiluminescence signal,
wherein a concentration of the graphene-based material is 0.5 μg/ml or more to 6 μg/ml or less,
wherein a concentration of the hydrogen peroxide is 5 to 20 mM, and
wherein a concentration of the acid is 1 to 24 mM.

22. The method of claim 21, wherein in the dispersing step, the acridinium ester-labeled immunocomplex and the first reagent are mixed and incubated for less than 5 minutes to reach an optimal condition to emit chemiluminescence with the addition of the second reagent.

23. The method of claim 21, wherein in the dispersing step, the acridinium ester-labeled immunocomplex and the first reagent are mixed and incubated for less than 1.5 minutes to reach an optimal condition to emit chemiluminescence with the addition of the second reagent.

24. The method of claim 21, wherein the sample is selected from the group consisting of serum, plasma, whole blood, stool, cerebrospinal fluid, synovial fluid, tissue, nasal swabs and urine.

25. The method of claim 21, wherein the sample is selected from the group consisting of drinking water, tap water, a vegetable, a fruit, a meat, or a contaminated material.

26. The method of claim 21, wherein the target antigen is an antigen derived from bacteria, cells, foodborne pathogens, peptides, proteins, haptens, or viruses.

27. The method of claim 21, wherein the target antigen comprises a small molecule antigen, a non-protein antigen, a cyclic antigen, or a single epitope antigen.

28. The method of claim 21, wherein the measuring the intensity of the chemiluminescence signal is performed less than 60 seconds after adding the second reagent.

29. The method of claim 21, wherein the second reagent further comprises an alkali metal salt having a halogen ion of F⁻, Cl⁻ or Br⁻.

30. The method of claim 29, wherein the alkali metal salt is selected from the group consisting of potassium chloride (KCl), sodium chloride (NaCl), cesium chloride (CsCl), sodium bromide (NaBr), potassium bromide (KBr), and sodium fluoride (NaF).

31. The method of claim 21, wherein the first reagent further comprises a chloride ion.
